(19) United States
(12) Patent Application Publication
(10) Pub. No.: US 2007/0290386 A1
(43) Pub. Date: Dec. 20, 2007

(54) Method and Apparatus for Project Light With Gel

(75) Inventors: Thomas Sirius Andersen, Aarhus (DK); Jan Oechsle Hansen, Aarhus (DK)

Correspondence Address: ROBERTS, MLOTKOWSKI & HOBBES, P. O. BOX 10064, MCLEAN, VA, 22102-8064, US

(73) Assignee: MARTIN PROFESSIONAL A/S, Aarhus N (DK)

(21) Appl. No.: 11/718,996

(22) PCT Filed: Nov. 10, 2005
(86) PCT No.: PCT/DK05/00720

§ 371 Date: Sep. 5, 2007

(30) Foreign Application Priority Data
Nov. 10, 2004 (DK) PA 2004 01726

(51) Int. Cl. B29C 73/14

(52) U.S. Cl. 264/36.12; 425/14

(57) ABSTRACT

A production light comprising a housing (1) with a synchronous driving mechanism with at least two rollers (2,4) where a film/band (6) of gels (8) is wound and taut between the rollers (2,4) so the aperture (10) of the production light is covered by the film/band (6), characterized in that the film/band (6) comprises of a plurality of separate sections of gels (8) where the gels (8) are attached to the film/band (6) by fastening means in such a way that each section of gel (8) is easily mounted or remounted onto the film/band (6).

### BACKGROUND OF THE INVENTION

1. Field of the Invention

The present invention relates to a method and apparatus for a project light with a GEL, which apparatus comprises a housing with a synchronous driving mechanism with at least two rolls where a film band of gels is wound and taught between the rollers so the aperture of the production light is covered by the film/band.

2. Description of Related Art

Project lights are used in TV, film or theatre production in order to obtain a better and more natural light setting. Project lights can be used to create a variety of different colors. A color media is used in front of the light, as an optical filter, so a more uniform color is achieved. In earlier days the color media was made of a natural material known as gelatine, which professionals in daily terms refer to as a “gel”. Gelatine was made of synthetic dye mixed with natural products, but nowadays, gels are made out of synthetic materials.

The main problem with the color media is that the color of the media fades out during use due to the high intensity, high heat lights. Therefore, the media has to be changed frequently in order to sustain a clean and uniform light.

Various inventions have been made concerning a production light with mechanical means for changing a gel or sheets thereof. In U.S. Pat. No. 5,988,835 a production light is disclosed comprising an attached disc having a plurality of colored gels. The gel is changed when the disc is rotated.

In U.S. Pat. No. 4,298,920 an automatic gel changer for a spot light is disclosed. The automatic gel changer can be operated for remote operation, including a rotary mechanism associated with frames of gel. This way, the gel could be changed by rotating a new frame in front of the aperture of the production light in order to change the GEL.

One of the downsides the aforementioned inventions is that the solutions are not very suitable for larger sized production lights because the frames of gel would occupy a considerable amount of space which is unsuitable.

U.S. Pat. No. 5,794,881 disclose a film tensioning device which maintains tension on the film where the film comprises a plurality of colored gels. The gel is wound between two rollers so the gel can be scrolled back and forth to change the gel e.g. the color of the gel. The invention uses a special spring system in order to keep the tension of the gel when the gel expands due to heat from the production light.

The film contains plurality of gels of different colors. Usually, one color is more preferred in a production setting than others and the film of gel have to be changed even though all the gels have not been used. Therefore, used films comprising sections of unused gels would eventually build up. There is a great risk that the films would never be fully used because the colors are rarely used in production. From an economical perspective this is to be avoided.

GB 2311874 describes scrolling device for scrolling coloured gels into positions in front of light source and controls electronic commutation of coils of motors, and/or to provide number of discrete positions of rotors of each of DC brushless servo-motors.

### SUMMARY OF THE INVENTION

It is therefore the object of the invention to provide a production light with a flexible system for the exchanging of a gel.

The object might be achieved if the film/band comprises of a plurality of separate sections of gels where the gels are attached to the film/band by fastening means in such a way that each section of gel is easily mounted or remounted onto the film/band. This way, a very flexible and economical solution for a gel exchanging system is achieved. The invention provides a flexible solution because it is possible to mount or remount single sheets of gels on the film which makes it possible to combine a tailor-made film of gel suitable for specific production setting or the like. At the same time the invention is economical favorably in relation to prior art because it prevents a build-up of half used films of gels of which the gel colors are rarely or never used in production.

By using the invention it is possible to combine a film with gels of only one color if that is what is preferred. A white and natural balanced light is often preferred in TV and film production and by using the present invention it is possible to achieve a production light with a film of gel where each sheet of gel is of that particular color only.

Furthermore, it is possible to make a quick and easy remount of new sheets of gels, as when a gel is faded, because of the high intensity light or the like. This way, a production stop due to exchange of a gel is shorten considerably compared to prior art because a single sheet of gel can be exchanged easy and quick without the need for changing the whole film.

If one scene is to be taken in a different light setting a single sheet of gel is easily exchanged with a gel of a different color. This is a great advantage according to known production lights that uses a film of fixed gels.

In an embodiment of the invention the sheet of gel is mounted onto the film/band by mechanical fastening means e.g. a number of small clips. This way, a sheet of gel is easily mounted or remounted by releasing the mechanical means. The mechanical means should either be small or pliable in order to be wrapped around the rollers.

In one embodiment of the invention the fastening mean is VELCRO®. VELCRO® should be mounted onto the film/band and to the sheets of gel for interaction with each other. This way, an easy and quick fastening mean is provided. Furthermore, because VELCRO® is pliable and flexible it is suitable for being wrapped around the rollers.

The fastening means should be located in such a way that shadows, in the cone of light, are avoided. This can be done by placing the fastening means at the outer edge of the gel and making the aperture of the production light smaller than the gel. The fastening mean could either be placed on the top and bottom or at the sides of the gel sheets.

In an alternative embodiment the fastening means between film band and gel might be chemical.

Hereby is achieved that the fastening means can be very flexibly during movement and folding around rollers.

In a preferred embodiment for the invention the fastening means could be in form of a adhesive tape, which adhesive tape can be placed on the edge of the sheet of gel, where the adhesive tape might adhere to the film band.

As an alternative the adhesive tape could be placed on the film/band and adhere to the sheet of gel. Herby is achieved that the sheet of gel can be exchanged very easily.

In stead an adhesive layer could be placed on the gel so the gel could adhere to the film/band.

In an embodiment of the invention the production light comprises an electronic information system that is capable of storing information about each section of gel such as color number, manufacturer, time of operation etc. This way, it is possible to keep track of each sheet of gel and ease the maintenance of the production light. By storing the time of operation for each sheet of gel it is possible for an operator to prepare the replacement of gels and new orders etc. This feature eliminates production stop due to short supply of gels etc.

In an embodiment of the invention the rollers and band/film have engaging means to interact with each other. This way, the band is correctly rolled and unrolled from the rollers during operation. In one embodiment of the invention the rollers comprises a plurality of small protrusion, such as teeth, at the outer circumference of the rollers in order to engage with corresponding holes in the band. The protrusions might be placed at the ends of the rollers or on other rollers that are in contact with the rollers.

The invention will be explained in more detail with reference to the drawing, where

### BRIEF DESCRIPTION OF THE DRAWINGS

FIG. 1 shows a production light with exchangeable sheets of gel.

FIG. 2 shows the band of gels taut and extended between the two rollers.

FIG. 3 shows the band held taut between the two rollers.

### DETAILED DESCRIPTION OF THE INVENTION

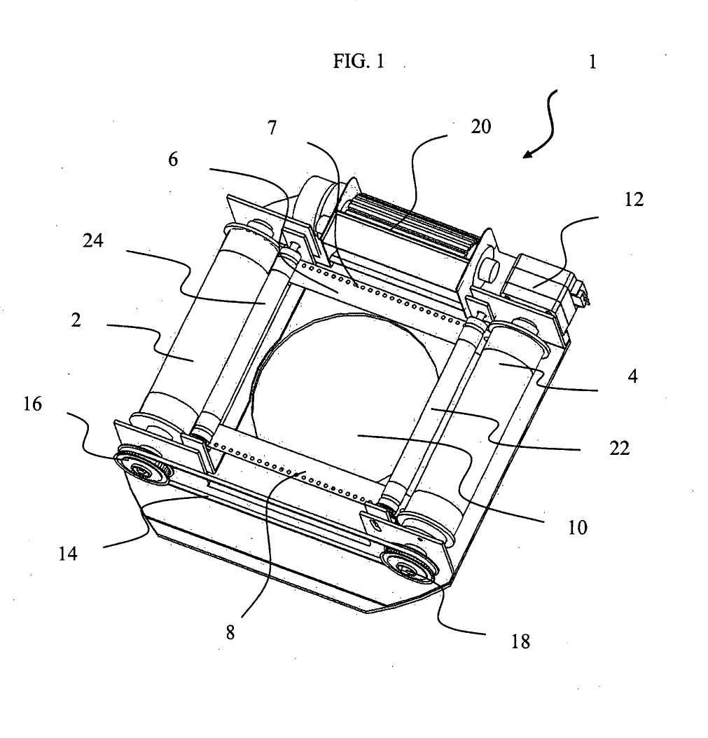

FIG. 1 shows a production light comprising of a housing 1 and an integrated synchronous driving mechanism which driving mechanism comprises of two rollers 2,4. An upper and lower band part 6 is held taut between the two rollers 2,4. A sheet of gel 8 is mounted onto the band parts 6 so the aperture 10 is covered when the door 9 of the housing 1 is closed. This way, the gel functions as a filter. The aperture 10 should be smaller than the gel in order to avoid shadows and artifacts from the band and the fastening means.

Two rollers 2, 4 are shown on the figure, but in an embodiment of the invention the production light could comprise more than two rollers. At least one of the rollers could in an embodiment of the invention be attached to an electric motor to scroll the band of gels.

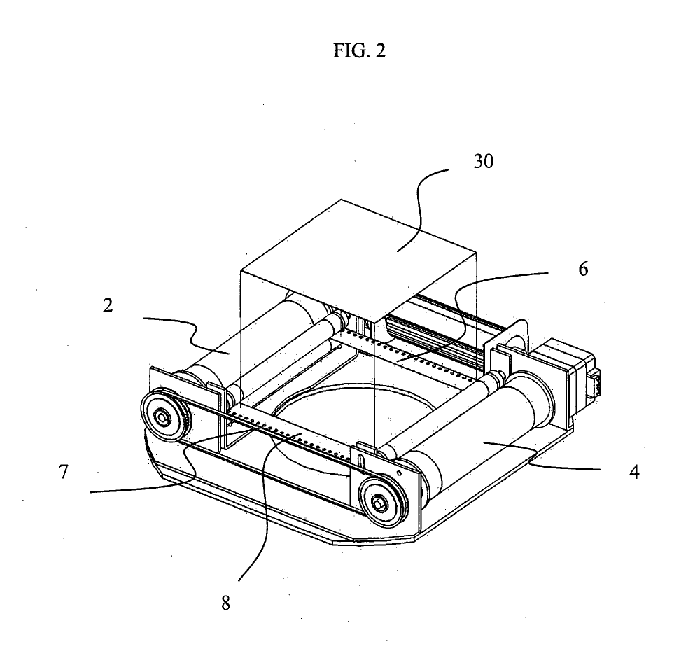

FIG. 2 shows a band 6 of gels, where a single sheet of gel 8 is taut between the two rollers 2, 4. The rollers is installed inside the housing of a production light (not shown) so the gel 8 is covering the aperture of the light to function as an optical filter. In FIG. 1 only two rollers 2,4 is illustrated, but in an embodiment of the invention the production light could comprise a number of interacting rollers. A driver mechanism such as an electrical motor would in an embodiment of the invention provide means for winding the band with attached sheets of gel.

FIG. 2 shows the rollers 2,4 and a band that is held taut between the two rollers 2,4. The band comprises a number of small equally spaced fastening means 10 in order to mount or remount sheets of gel onto the band 6. The band 6 further comprises a plurality of equally spaced holes in order for the band to engage to the teeth (not shown) of the rollers. The interaction of the teeth of the rollers 2,4 and the holes in the band assures that the rolling and unrolling is correct. In another embodiment of the invention the engaging mechanism could be slides or the like in order to guide the band correctly onto the rollers 2,4.

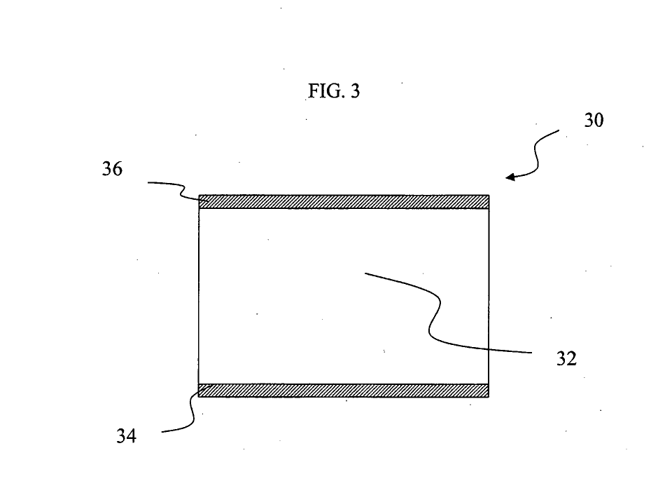

FIG. 3 shows a gel 30, which contains fastening means 34,36 along the upper and lower edge of the gel 30, between fastening means 34,36 is shown the active gel area 32.

What is claimed is:

1-10. (canceled)

11. A production light comprising a housing with a synchronous driving mechanism with at least two rolls where a film/band of gels is wound and taut between the rollers so the aperture of the production light is covered by the film/band, wherein the film/band comprises of a plurality of separate sections of gels where the gels are attached to the film/band by fastening means in such a way that each section of gel is easily mounted or remounted onto the film/band.

12. Production light according to claim 11, wherein fastening means is mechanical.

13. Production light according to claim 11, wherein the sheets of gel are fastened to the film/band by pliable fastening means, such as VELCRO®.

14. Production light according to claim 11, wherein fastening means is chemical.

15. Production light according to claim 14, wherein fastening means is in form of a adhesive tape, which adhesive tape is placed on the edge of the sheet of gel, where the adhesive tape adhere to the film band.

16. Production light according to claim 11, wherein the production light comprises an electronic information system that stores information about each section of gel such as color number, manufacturer, time of operation etc.

17. Production light according to claim 11, wherein the production light comprises an electro motor connected to the rollers by transmission means.

18. Production light according to claim 11, wherein the rollers and film/band have engaging means to interact with each other.

19. Production light according to claim 11, wherein the rollers has protrusions to engage with corresponding holes in the film/band.

20. Method for exchanging gels in a production light comprising at least two rollers onto which a film/band of gels is taut and wound, wherein each sheet of gel is attached to the band with releasable fastening means in such a way that the gel can be mounted and remounted onto the band.
